(19) United States
(12) Patent Application Publication
(10) Pub. No.: US 2008/0033991 A1
(43) Pub. Date: Feb. 7, 2008

(54) PREDICTION OF FUTURE PERFORMANCE OF A DBMS

(76) Inventors: Jayanta Basak, New Delhi (IN); Manish Anand Bhide, New Delhi (IN); Laurent Sebastien Mignet, New Delhi (FR); Sourashis Roy, New Delhi (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/462,093

(22) Filed: Aug. 3, 2006

(51) Int. Cl. G06F 17/00

(52) U.S. Cl. 707/104.1

(57) ABSTRACT

A method and system to predict future performance of a database management system (DBMS) is disclosed. The invention uses a time series of historical data of operating parameters to predict future values of the operating parameters. The predicted future values of the operating are used to predict the future performance of the DBMS.

### FIELD OF THE INVENTION

The present invention relates to Database Management System (DBMS). More particularly, the present invention relates to predicting future performance of the DBMS.

### BACKGROUND OF THE INVENTION

Various kinds of database have been in use since the early days of electronic computing. In order to store and retrieve data from the database, a database management system (DBMS) is used. The database management system is a set of software programs that are linked to one or more database. As electronic commerce has gained prevalence, organizations have become increasingly dependent on database management systems for processing ever larger volumes and more critical nature of electronic data. A failure of these database management systems can potentially result in a huge loss of money. Moreover, loss of such data may lead to dissatisfaction of customers and depreciate the market value of the organization. Hence, it is critically important to ensure high reliability of such database management systems.

The challenge faced by the operators and system administrators of such database management systems is how to detect and diagnose performance problems with the database management system in a timely manner, before the problem reaches a critical stage and results in a system failure. Upon pre-detection of the future performance problems, the operator can be warned and a possible failure of the database management system can be averted.

The performance of the database management system depends on various operating parameters such as memory usage, CPU time, and caching. The operating parameters govern effective usage of the database management system. One approach to address the aforementioned problem is to convert historical data of the operating parameters into meaningful recommendations and warnings of the future performance of the database management system. Some of the current database management systems, such as Oracle, only provides current trend with low reliability. But none of the current database management systems have an early warning system.

There exists a need to provide meaningful recommendations and warnings about the system performance to the operator. There also exists a need for a method to analyze the historical data of the operating parameters in order to predict the future performance of the DBMS.

### SUMMARY OF THE INVENTION

The present invention relates to a method and system to predict future performance of a Database Management System (DBMS).

The present invention provides a method for predicting a future performance of a database management system. The method comprises extracting historical data of one or more operating parameters of the database management system for a predetermined time period. The method also comprises building a trend of the historical data and predicting the future performance of the DBMS by calculating future values of the operating parameters based on the trend.

The invention discloses the use of historical data of operating parameters to predict the future performance of the DBMS. The trend of historical data is mathematically modeled to predict their future values that govern the performance of the DBMS. The mathematical model is incrementally built based on the values measured over a period of time thereby increasing the robustness and the confidence value of the predicted operational parameters.

The present invention also provides for a computer program product and an apparatus embodying the aforementioned method.

### BRIEF DESCRIPTION OF THE DRAWINGS

The above and other items, features and advantages of the invention will be better understood by reading the following more particular description of the invention in conjunction with the accompanying drawings, wherein:

FIG. 1 illustrates a computer system used as a Database management system in accordance with an embodiment of the present invention.

FIG. 2 is a flowchart of a method for predicting the future performance of the DBMS in accordance with an embodiment of the present invention.

FIG. 3 illustrates the steps of qualifying the historical data in accordance with an embodiment of the present invention.

FIG. 4 illustrates the sub-steps of building a trend of historical data in accordance with an embodiment of the present invention.

FIG. 5 illustrates the sub-steps of predicting the future values in accordance with an embodiment of the present invention.

FIG. 6 illustrates the sub-steps of analyzing the reliability of the predicted future values in accordance with an embodiment of the present invention.

FIG. 7 illustrates the steps of warning an operator about the future performance of DBMS in accordance with an embodiment of the present invention.

### DETAILED DESCRIPTION

The present invention would now be explained with reference to the accompanying figures. Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The present invention may take the form of an entirely hardware embodiment, an entirely software embodiment or an embodiment containing both hardware and software elements. In accordance with an embodiment of the present invention, the invention is implemented in software, which includes, but is not limited to firmware, resident software, microcode, etc.

Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and DVD.

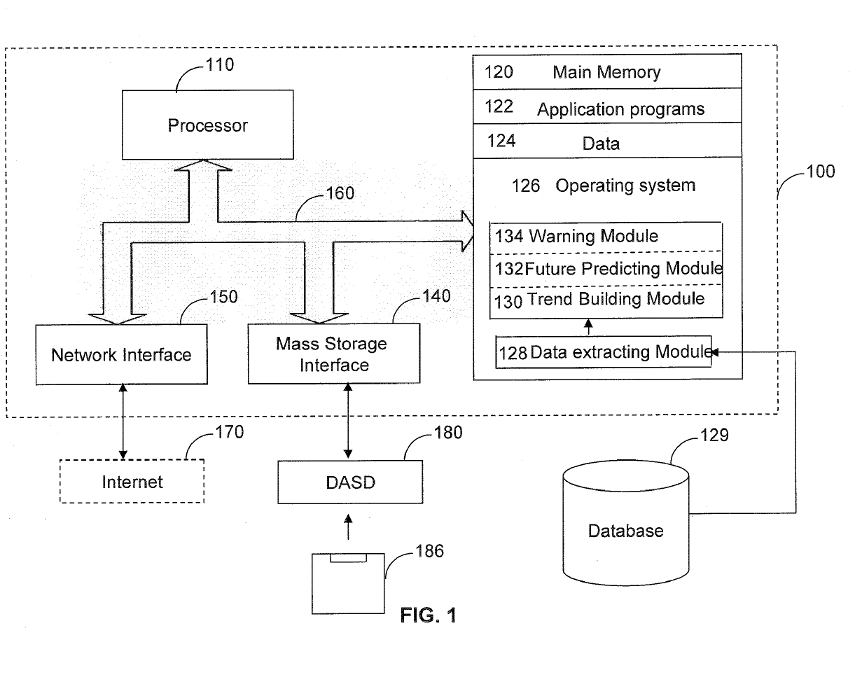

FIG. 1 depicts a block diagram of a computer system 100 used as a database management system (DBMS) in accordance with an embodiment of the present invention, which includes a processor 110, a main memory 120, a mass storage interface 140, and a network interface 150, all connected by a system bus 160. Those skilled in the art will appreciate that this system encompasses all types of computer systems: personal computers, midrange computers, mainframes, etc. Note that many additions, modifications, and deletions may be made to this computer system 100 within the scope of the invention. Examples of possible additions include: a display, a keyboard, a cache memory, and peripheral devices such as printers.

Processor 110 may be constructed from one or more microprocessors and/or integrated circuits. Processor 110 executes program instructions stored in main memory 120. Main memory 120 stores programs and data that computer system 100 may access. Main memory 120 includes one or more application programs 122, data 124, operating system 126, data extracting module 128 extracting the historical data from a database 129, trend building module 130, future predicting module 132 and warning module 134. When computer system 100 starts, processor 110 initially executes the program instructions that make up operating system 126. Operating system 126 manages the resources of computer system 100 for example, processor 110, main memory 120, mass storage interface 140, network interface 150 and system bus 160.

Application programs 122 are executed by processor 110 under the control of operating system 126. Application programs 122 may be run with program data 124 as input. Application programs 122 may also output their results as program data 124 in main memory. In one embodiment of the present invention, computer system 100 includes data extracting module 128 to extract the historical data of at least on operating parameter from database 129. Computer system 100 also includes trend building module 130 to build a trend of the historical data for each of the operating parameters and a future predicting module 132 to predict future performance of a Database management system (DBMS). Further, computer system 100 includes warning module 134 to warn an operator about the future performance of the DBMS based on the predicted future performance. The “modules” are software codes that may be a callable routine or embedded into another program, i.e., an operating system or application program. For example, although the modules are shown as a part of operating system 126 in accordance with one embodiment of the invention, it is equally within the scope of the present invention to provide a separate software application or utility that could also provide data extracting module 128, trend building module 130, future predicting module 132 and warning module 134. In accordance with an embodiment of the present invention, the modules may be provided as independent modules. In accordance with another embodiment of the present invention, the modules may be clubbed together.

Mass storage interface 140 allows computer system 100 to retrieve and store data from auxiliary storage devices such as magnetic disks (hard disks, diskettes) and optical disks (CD-ROM). These mass storage devices 180 are commonly known as Direct Access Storage Devices (DASD), and act as a permanent store of information. One suitable type of DASD 180 is a floppy disk drive 180 that reads data from and writes data to a floppy diskette 186. The information from the DASD may be in many forms. Common forms are application programs and program data. Data retrieved through mass storage interface 140 is usually placed in main memory 120 where processor 110 may process it.

While main memory 120 and DASD 180 are typically separate storage devices, computer system 100 may use well known virtual addressing mechanisms that allow the programs of computer system 100 to run smoothly as if having access to a large, single storage entity, instead of access to multiple, smaller storage entities (e.g., main memory 120 and DASD device 180). Therefore, while certain elements are shown to reside in main memory 120, those skilled in the art will recognize that these are not necessarily all completely contained in main memory 120 at the same time. It should be noted that the term “memory” is used herein to generically refer to the entire virtual memory of computer system 100. In addition, an apparatus in accordance with the present invention may include any possible configuration of hardware and software that contains the elements of the invention, whether the apparatus is a single computer system or is comprised of multiple computer systems operating in sync with each other.

Network interface 150 allows computer system 100 to send and receive data to and from any network connected to computer system 100. This network may be a local area network (LAN), a wide area network (WAN), or more specifically, the Internet 170. Suitable methods of connecting to a network include known analog and/or digital techniques, as well as networking mechanisms that are being developed or may be developed in the future. Various different network protocols may be used to implement a network. These protocols are specialized computer programs that allow computers to communicate across a network. TCP/IP (Transmission Control Protocol/Internet Protocol), used to communicate across the Internet, is an example of a suitable network protocol.

System bus 160 allows data to be transferred among the various components of computer system 100. Although computer system 100 is shown to contain only a single main processor and a single system bus, those skilled in the art will appreciate that the present invention may be practiced using a computer system that has multiple processors and/or multiple buses. In addition, the interfaces that are used in the preferred embodiment may include separate, fully programmed microprocessors that are used to off-load compute-intensive processing from processor 110, or may include I/O adapters to perform similar functions.

The present invention provides a method for predicting the future performance of a database management system (DBMS). On basis of early warnings generated as a result of prediction, the operator can take one or more corrective actions, to reduce the chances of a system failure. The performance of the DBMS depends on various operating parameters of the DBMS. The operating parameters may include memory usage, CPU time, transactions per time, file system fill grade, transaction log space used, CPU utilization, disk utilization, buffer pool hit ratio at database level, table space level, buffer pool level and caching. These operating parameters govern the effective usage of the DBMS during interaction of the operator. In accordance with an embodiment of the present invention, the prediction of the future performance of the DBMS is provided to the operator by predicting future values of the operating parameters.

Trend analysis or time series techniques are applied to predict the future values of the operating parameters. Trend analysis or time series analysis is known to predict and forecast future values of different variables in a huge number of domains. The domains include market research, stock market analysis and prediction, finance, politics (such as election campaigns), population study, economics, crime analysis and forensic applications, chemistry, geographical and geological analysis, medical data analysis, Electro-Encephalogram (EEG) and Magneto-Encephalogram (MEG) data analysis, web intelligence, intrusion detection, sequential data mining and various other fields. The method of an embodiment of the present invention predicts the future value of the operating parameters on the basis of the trend of data points of historical data of the operating parameters. The data points of historical data are past values of the operating parameters.

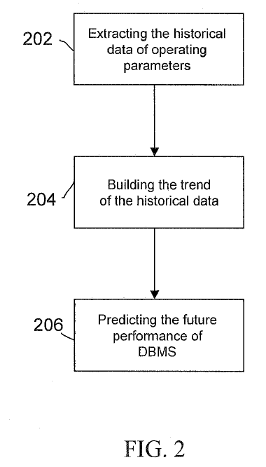

FIG. 2 is an overview flow chart illustrating a method of predicting the future performance of the DBMS in accordance with an embodiment of the present invention. At step 202, historical data of the operating parameters is extracted from the database. The historical data of the operating parameters is gathered at predetermined time intervals from the DBMS system. The time interval is the duration between two consecutive observations of the operating parameters. It is “chunk-wise” constant and may vary depending on the nature of the operating parameters. “Chunk-wise” is defined as an entire time series partitioned into multiple chunks of same size, such that the time interval in each chunk is constant. Further, the time interval may also vary or change over the time on the basis of usage pattern of the operating parameters and the operator requirements. At step 204, a trend of the historical data is detected. Step 204 builds a mathematical model of the trend on the basis of the historical data extracted at step 202. At step 206, the future performance of the DBMS is predicted on the basis of predicted future values of the operating parameters. The future values are predicted using the trend of the historical data.

In accordance with the present invention, the future values of the operating parameters are predicted using the historical data stored in the database. Many of the operating parameters of the DBMS are non-stationary, i.e., they change during the course of operation of the DBMS, for example CPU time. Moreover, the historical data may consist of spikes and exhibit no patterns. The spikes and absence of pattern can cause an error in prediction of the future values. In an embodiment of the present invention, the extracted historical data is qualified before building the trend 204.

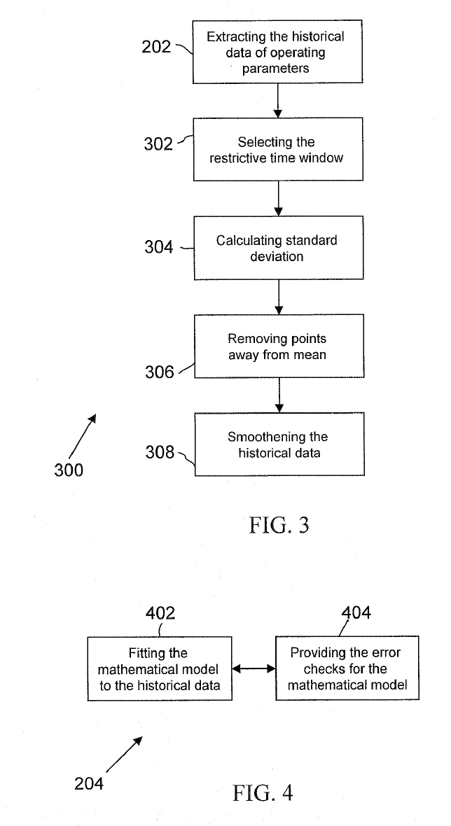

FIG. 3 illustrates steps of qualifying the historical data 300. In addition to step 202, a time window size of historical data is selected out of the entire extracted historical data in step 302. The time window is the time interval for which the historical data is to be qualified. At step 304, a standard deviation of the historical data is calculated over the time window. The standard deviation σ at a time point p of the time window of size (2W+1) can be calculated as

$$σ = \sqrt{\frac{1}{( 2 W + 1 )} {\sum }_{i = - W}^{i = + W} {( {x}_{p + i} - {μ}_{p} )}^{2}}$$

where xₚ₊ᵢ is the value of operating parameter at a point p+i and μₚ is the computed mean of the historical data at the point p over a window size (2W+1) spanning from p−W to p+W. At step 306, all the values of the operating parameters away from the mean μₚ by a predetermined factor of the standard deviation are removed. In an embodiment of the present invention the predetermined factor is taken as 2. This may restore 95% of the points and 5% of points as outliers. The outliers in a set of numerical data are any value that is markedly smaller or larger than other values in the data set. In the instant invention the historical data is the numerical data set from which the outliers are removed. In an embodiment of the present invention, next step 308, smoothening of the historical data removes the spikes from the historical data for the restrictive time window (2W+1). It will be obvious to one skilled in the art that different smoothening algorithms such as Gaussian Convolution may be used for smoothening the historical data.

FIG. 4 illustrates the sub-steps of building a trend of historical data 204 according to an embodiment of the present invention. Step 402 fits a mathematical model to the historical data. In an embodiment of the present invention an auto regressive mathematical model is used. In the autoregressive model, the current values of the operating parameters are expressed as the weighted linear sum of w historical observations of the corresponding operating parameter in addition to a Gaussian noise ε. It is known to one skilled in the art that, with assumption of Gaussian noise, the minimization of the noisy term leads to regression estimate. The number of historical observations w is a default value, set after analyzing values of the operating parameters. Fitting the auto regressive mathematical model to the historical data can be represented as

$$\begin{matrix}{x}_{n} = {a}_{1 s} {x}_{n - s - 1} + {a}_{2 s} {x}_{n - s - 2} + {a}_{3 s} {x}_{n - s - 3} + … + {a}_{ws} {x}_{n - s - w} + {ɛ}_{1} \\ {x}_{n - 1} = \begin{matrix}{a}_{1 s} {x}_{n - s - 2} + {a}_{2 s} {x}_{n - s - 3} + {a}_{3 s} {x}_{n - s - 4} + … + \\ {a}_{ws} {x}_{n - s - w - 1} + {ɛ}_{2}\end{matrix} \\ ⋮ = ⋮ \\ {x}_{n - T + s + w + 1} = \begin{matrix}{a}_{1 s} {x}_{n - T + s + w} + {a}_{2 s} {x}_{n - T + s + w - 1} + \\ {a}_{3 s} {x}_{n - t + s + w - 2} + … + {a}_{ws} {x}_{n - T + 1} + {ɛ}_{T - s - w}\end{matrix}\end{matrix}$$

Where xₙ is most recent observed value of the operating parameter that is to be predicted, x_{n-T+1}, x_{n-T+2}, . . . , xₙ is the historical data for a time length T and a₁ₛ, a₂ₛ, a₃ₛ, . . . a_{ws} are auto correlation coefficients. It is known to those skilled in the art that, if number of the historical observation w is more than the required time length, then the extra auto correlation coefficients take very small value. In the matrix notation the auto regressive mathematical model can be expressed as

$${y}_{s} = {X}_{s} {a}_{s} + ɛ$$

$$where$$

$${y}_{s} = {[ \begin{matrix}{x}_{n} & {x}_{n - 1} & ⋯ & {x}_{n - T + s + w + 1}\end{matrix} ]}^{T} , \\ {X}_{s} = [ \begin{matrix}{x}_{n - s - 1} & {x}_{n - s - 2} & ⋯ & {x}_{n - s - w} \\ {x}_{n - s - 2} & {x}_{n - s - 3} & ⋯ & {x}_{n - s - w - 1} \\ ⋮ & & & \\ {x}_{n - T + s + w} & {x}_{n - T + s + w - 1} & ⋯ & {x}_{n - T + 1}\end{matrix} ] , \\ and$$

$${a}_{s} = {[ \begin{matrix}{a}_{1 s} & {a}_{2 s} & ⋯ & {a}_{ws}\end{matrix} ]}^{T} .$$

Minimization of Gaussian noise ε, considering a generating Gaussian process, the mathematical model fit with the historical data can be calculated as

aₛ=(Xₛ^{T}Xₛ)⁻¹Xₛ^{T}yₛ

Further a decay matrix may be used to minimize the Gaussian noise ε more for the recent values of operating parameters and less for the past observations. In an embodiment of the present invention an exponential decay is used for estimation of aₛ. The exponential decay is defined as [1 1/k . . . 1/k^{w}], such that the error for the most recent observation has the maximum weight of unity and the error in the next observation has a weight of 1/k, the weight of the next one is 1/k² and so on. The mathematical model fit with the historical data can be calculated as

$${a}_{s} = {( {X}_{s}^{T} {DX}_{s} )}^{- 1} {X}_{s}^{T} {Dy}_{s}$$

$$Where$$

$$D = [ \begin{matrix}1 & 0 & ⋯ & 0 \\ 0 & 1 / k & ⋯ & 0 \\ & ⋮ & & \\ 0 & 0 & ⋯ & 1 / {k}^{w}\end{matrix} ]$$

One of ordinary skill in the art will appreciate that various decay, including logarithmic decay, may be used in the embodiments without departing from the scope of the present invention.

At step 404, error checks for the mathematical model are provided. The error check may include, if any of the historical value of the operating parameter is not accessible, and if the number of the historical observations is not enough to enable a proper learning of the mathematical model.

In accordance with the method of the present invention, the future values fixed time-interval ahead is predicted using the current value and the previous w values of the operating parameter in the history.

FIG. 5 illustrates the sub steps of predicting the future values 206. At step 502, the future value s fixed time-interval ahead of operating parameter is predicted using the mathematical model as

xₙ₊ₛ=z^{T}aₛ

Where z=[xₙ xₙ₋₁ . . . x_{n-w+1}]^{T}, are the current values and the previous w values of the operating parameter. After observing the current value of the operating parameters, the matrix XS is recomputed incrementally in step 504. Using this approach the mathematical model need not to built at every instance in the time period. Using the present values of the operating parameters and the latest mathematical model, a new mathematical model can be arrived at. The first row of the matrix Xₛ is pushed to the second row and so on by obtaining only first element of the matrix. The current value of the operating parameter is used as the first element of the matrix. Every time one row at the top of Xₛ is included, and one row from the bottom of Xₛ is deleted. A similar operation is performed on matrix DXₛ. At step 506, the mathematical model is updated using the new matrices Xₛ and DXₛ as

aₛ=(Xₛ^{T}DXₛ)⁻¹Xₛ^{T}Dyₛ

An embodiment of the present invention includes a module for analyzing a reliability of the predicted future values.

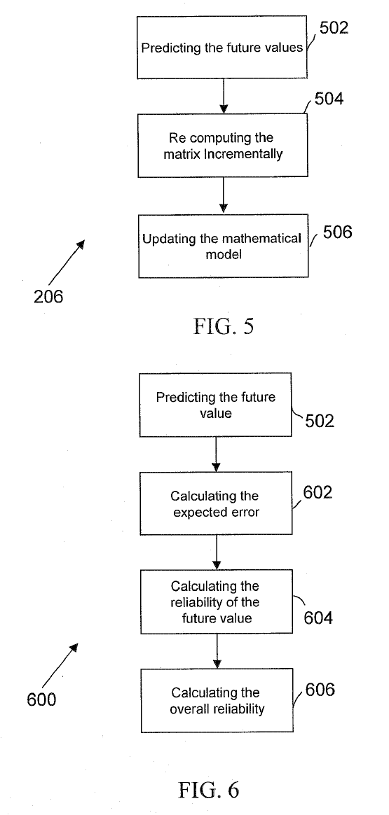

FIG. 6 illustrates the sub-steps of analyzing the reliability of the predicted future values 600. In addition to step 502, an expected error of the predicted future data is calculated in step 602. The error Eₛ of the estimated future value vₛ=Xₛaₛ is calculated as

Eₛ=∥yₛ−vₛ∥²

Where, yₛ is actual observation of the operating parameter. At step 604, the reliability of the predicted future values is calculated as

$${R}_{s} = erf ( \frac{C}{\sqrt{2 {E}_{s}}} )$$

Where, C is a predetermined threshold and is provided by the operator. At step 606, an overall reliability of the future values over a given prediction length of s is calculated. The overall error is calculated as

$$E = \frac{1}{s} {\sum }_{i = 1}^{s} {E}_{i}$$

The overall reliability over the prediction length s is calculated as

$${R}_{s} = erf ( \frac{C}{\sqrt{2 E}} )$$

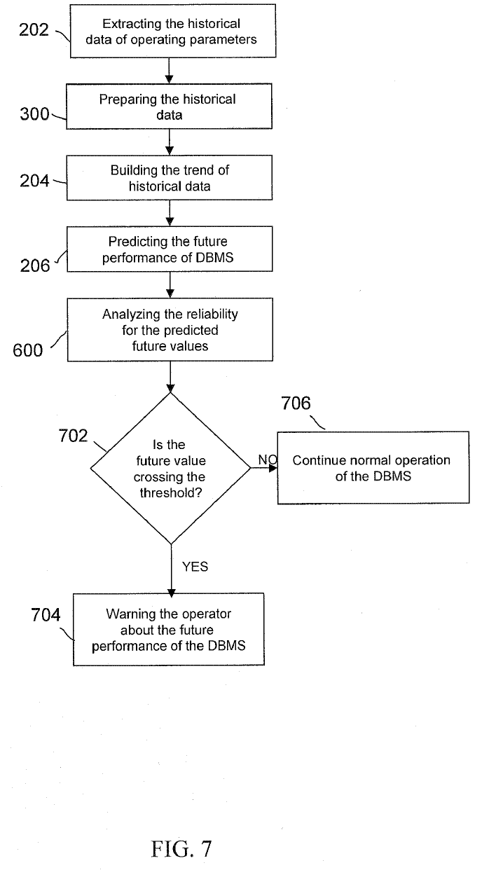

FIG. 7 is a flow diagram representation of a method for warning an operator about the future performance of DBMS according to an embodiment of the present invention. The historical data of the operating parameters is extracted from a database at the predetermined time interval in step 202. At next step 300, the historical data is prepared for building the trend of historical data. Step 204 fits a mathematical model to the historical data. At next step 206, the future performance of the DBMS is predicted. Step 600 analyzes the reliability of the predicted future values of the DBMS. At step 702, a check is made to determine whether the predicted future values of the operating parameters cross one or more predetermined thresholds for each operating parameter. The predetermined thresholds depend on the nature of the operating parameters. If one or more predicted future values cross the predetermined thresholds the operator is warned about the future performance of the DBMS in step 704 otherwise the normal operation of the DBMS is continued 706.

Integration with IBM DB2 Performance Expert®

For illustrative purposes, exemplary use cases of implementation of the present invention, in the IBM DB2 Performance expert current product would now be explained. The exact implementation may vary for different DBMS, but the inventive concept can be applied to other systems without departing from the spirit and scope of the invention. Application Programming Interfaces (APIs) are used to interact with the database.

Use Case 1: Time Series Learning

A time series learning module is provided for the building of the mathematical model from a single time series. The time series learning module is provided with a set of numeric time series segments as input. The time series segments are tagged with the operating parameter and consist of finite sets of data points. Each of the data points consists of a numeric value of the operating parameter and an associated timestamp. The time interval between the consecutive data points is “chunk-wise” constant. For each time series segment specified in the input, the time series learning module learns the mathematical model that describes its trend. The mathematical model can also be used to predict the future values of the operating parameter.

The time series learning module is provided with a set of option settings that can be used to control behaviors of the time series learning. The time series learning options include incremental, renewed learning, and additional suggestions about the time series. Further, the time series learning option permits to specify number of the data points that will be used to compute the smoothening factor of internal algorithm used to construct the mathematical model.

### API Used:

IDataRange is an Interface for a data container having a simple time-data range. The implementing class is used to provide a set of timestamp and double values. The amount of timestamps and values is the same and matching by index. So the timestamp at index [n] corresponds to the double value at index [n]. Timestamps are provided in workstation format (ticks since the 1 Jan. 1970). The implementing class is simply a data transporter/container for a range of values over time, such as values of the same counter through a specific time frame. The timestamps are ordered so that the data values with a lower index occur before the ones with a higher index.

```
public interface IDataRange {
    /**
    * Returns the amount of available data points.
    *
    * @return long The amount of delivered data points
    */
    public long getSize( );
    /**
    * Returns the <i>ticks</i> timestamps for the data snapshot.
    * The passed in index has the range from 0..getSize − 1.
    *
    * @parameter index long The zero based index
    * @return long The timestamp value
    */
    public long getTimeStamp( long index );
    /**
    * Returns the data value for the specified index.
    * The passed in index has the range from 0..getSize − 1.
    *
    * @parameter index long The zero based index
    * @return double The data value for that index
    */
    public double getValue( long index );
}
```

Use Case 2: Trend Detection

A trend detection module is provided to detect the trend of the historical data of the operating parameters. The trend detection is explicitly targeted for one or more of the following operation parameters:

Transactions per time (PWH.DBASE. NB_OF_UOW)
Sorts per transactions (PWH.DBASE.TOTAL_SORTS / NB_OF_UOW)
Nr. of applications (PWH.DBASE.APPLS_CUR_CONS)
Table space fill grade (not yet in PWH, just in history:
DB2PM.NODEIFTBSP.TABLESPACE_USED_PAGES_RATIO
(per Node))
File system fill grade (SMS container:
PWH.FILESYSTEM.PCT_USED_SPACE
Transaction log space used (PWH.DBASE.TOTAL_LOG_USED)
Lock wait per transaction (PWH.DBASE.LOCK_WAITS /
NB_OF_UOW)
CPU utilization (PWH.CPUSTATISTICS.PCT_USER_TIME +
PCT_SYSTEM_TIME)
Disk utilization (PWH.DISKSTATISTICS.DISKIOCOUNTER)
Buffer pool hit ratio at database level , table space level , buffer pool level
(PWH.DBASE.POOL_HIT_RATIO,
PWH.TABLESPACE.POOL_HIT_RATIO,
PWH.BUFFERPOOL.POOL_HIT_RATIO)
Nr. of connections (PWH.DBASE.TOTAL_CONS)
Lock wait time per transaction (PWH.DBASE.LOCK_WAIT_TIME /
NB_OF_UOW)
Arrival rate (statement base):
(PWH.DBASE.DYNAMIC_SQL_STMTS +
STATIC_SQL_STMTS − FAILED_SQL_STMTS)
Rows selected/rows read (read efficiency:
PWH.DBASE.ROWS_SELECTED /ROWS_READ)
Avg. response time of SQL statements
(PWH.DBASE.DBASE_ELAPSED_EXEC_TIME / <arrival rate,
see above>)

The trend detection module calculates a trend value for each corresponding timestamp in the time series using the mathematical model learned in USE CASE 1.

The start of the time period over which the trend detection is requested must not be earlier than the start of the time interval of corresponding time series specified in the learning phase. The end of the time period over which trend detection is requested must not be later than the end of the time interval of corresponding time series specified in the learning phase.

Use Case 3: Trend Prediction

A trend prediction module is provided to predict future data points using the mathematical model learned in the USE CASE 1. For each timestamp in the output time series, corresponding predicted values are calculated. Along with each predicted value, a confidence indicator is calculated.

Start time of the tine period over which the trend prediction is requested must be later than the end of the time period of the time series specified in the learning phase.

### API Used:

ITrendAnalyzer is an Interface for the trend analyzer backend engine. The class which implements this interface is supposed to compute trends, trend predictions and confidence levels on data ranges, which are passed in the form of a training set to the learnDataRange method. The IDataRange interface is used to pass in the training data. After the training has been performed, the implementing class returns trend values for specific time frames and granularity through the getTrend method. The time frame may be within the same time range as the training data, or can also specify a time window beyond the training data to predict a trend in the future. Incremental training should also be supported by the learnDataRange method. This means that the training data is not added in a single range but as an initial training set. Then a trend might be requested through the getTrend method on the base of the already learned data. Later on, another set of training data (which is the next valid time slice after the already learned training data) is added through the learnDataRange method. The class then needs to optimize the trend prediction, based on the previously added training data with the help of the new, incremental specified data range. Therefore, a subsequent call to the getTrend method should return a data range trend with improved quality. Therefore, the learning process can be called several times to incrementally increase the quality. Only by calling the reset method, all so far learned values are dropped and the next learning cycle starts from scratch again. The getTrend method can only be called after training data has been processed.

public interface ITrendAnalyzer
{
/**
* Specifies the data for the training phase.
* The trend engine uses this data to learn and find
* out the trend function. The <i>Map</i>, passed in as first parameter
* has <i>String</i> instances as keys and <i>IDataRange</i> instances
* as mapped values. The key is the variable name while the value is
* the data range for this variable. The second parameter can specify
* optional data like variable names for which to have parameterized
* learning. The content of <i>options</i> is not specified at this
* point of time and can also be <i>null</i>.
*
* @parameter rangeMap Map The map with variables to IDataRange values
* @parameter options Properties The optional parameter options
* -> “Smoothing Windows” option will specify the number of data points
* taken in account by the step responsible to smooth the input.
* -> “Confidence Interval” option. By Default the trend predictor will
* use a default bandwidth of 3 percent to be able to calculate the confidence
* level for each forecasted value. This option permits the user to overide the
* default value.
*/
public void learnDataRange(Map rangeMap, Properties options);
/**
* Returns the trend (or prediction) for a specific time range. This method returns a set of
*trend values for a time range starting at from and leading to to. The last parameter
*stepSize is used to define the granularity of the output data.
* @parameter variable String The variable for which to get the trend
* @parameter from long The timestamp (ticks) to start the trend
* @parameter to long The timestamp (ticks) to end the trend
* @parameter stepSize long The stepsize (ticks) for the granularity
* @return IOutputDataRange The requested data array with the values
*/
public IOutputDataRange getTrend(String variable, long from, long to,
long stepSize);
/**
* Causes the reset of this instance.
* All learned data is forgotten and reset by a call to this
* method so that the instance can be reused for another analyze
* cycle.
*/
public void reset( );
}

Use Case 4: Prediction Quality Statement

A module is provided for a quality statement to describe the prediction quality of the chosen mathematical model. The module calculates an expected error of the predicted future data. The module also calculates the reliability of the predicted future values. Thereafter, an overall reliability of the future values over a given prediction period is calculated.

### API Used:

IOutputDataRange is an extended data container, adding confidence information. This interface defines a container that has the same support for raw timestamp/double value sets as the inherited IDataRange interface but it extends this information by confidence levels. The scalar overall confidence level returns the average confidence, detected for a computed trend and the confidence level for each of the data points, which are returned. Therefore the index based confidence returns the value of the confidence function which is computed in parallel to the trend values. This extended interface can be the output data container of a trend computation. Therefore, it carries out the resulting trend together with the detected confidence values.

```
public interface IOutputDataRange extends IDataRange {
    /**
    * Returns the overall confidence level of the predicted trend.
    *
    * @return double The overall confidence level
    */
    public double getOverallConfidence( );
    /**
    * Returns the confidence for a specific point of time, given by index.
    * The index has the range from 0..getSize − 1
    *
    * @parameter index long The zero based index
    * @return double The confidence level for the specified data point
    */
    public double getConfidence( long index );
}
```

Use Case 5: Iterative Time Series Learning

An iterative time series learning module is provided for incremental learning of the data points in the future. Instead of rebuilding the mathematical model at every instance of time when parameters are to be predicted, the existing mathematical model is incrementally updated to reflect the new subsequent time series data input.

In the aforesaid description, specific embodiments of the present invention have been described by way of examples with reference to the accompanying figures and drawings. One of ordinary skill in the art will appreciate that various modifications and changes can be made to the embodiments without departing from the scope of the present invention as set forth in the claims below. Accordingly, the specification and figures are to be regarded in an illustrative rather than a restrictive sense, and all such modifications are intended to be included within the scope of present invention.

I/We claim:

1. A method for predicting a future performance of a database management system (DBMS), the method comprising:
extracting historical data of one or more operating parameters of the DBMS for a predetermined time period;
building a trend of the historical data; and
predicting the future performance of the DBMS by calculating the future values of one or more operating parameters based on the trend.

2. The method of claim 1, further comprising removing outliers from the historical data.

3. The method of claim 2, wherein removing the outliers from the historical data comprises:
selecting a time window in the historical data, wherein one or more operating parameters of the historical data are to be analyzed;
calculating a mean and a standard deviation of data points of the historical data for each operating parameter for the entire time window; and
for each operating parameter, removing the data points based on the calculated mean and the standard deviation.

4. The method of claim 1, further comprising smoothening the historical data.

5. The method of claim 4, wherein smoothening of the historical data is based on Gaussian convolution.

6. The method of claim 1, wherein the operating parameters include memory usage, CPU time, transaction per time, sorts per transactions, number of applications, table space fill grade, file system fill grade, transaction log spaced used, lock wait per transaction, disk utilization, and caching to name a few.

7. The method of claim 1, further comprising warning a user of a critical system state on the basis of the future values of the operating parameters.

8. The method of claim 7, wherein warning the user of the critical system state is based on at least one of a predetermined threshold value of the operating parameters.

9. The method of claim 1, wherein building the trend of the historical data comprises fitting a mathematical model on the historical data.

10. The method of claim 1, wherein building the trend of the historical data comprises assigning different weights to the historical data of the operating parameters.

11. The method of claim 9, wherein fitting the mathematical model is performed using algorithms including auto-regression (AR) algorithm, auto-regression with moving average (ARMA) algorithm, auto-regression with integrated moving average (ARIMA) algorithm, fuzzy-theoretic tools, and neural networks.

12. The method of claim 1, further comprising calculating a confidence value for each of the calculated future values of one or more operating parameters.

13. The method of claim 1, wherein the future values of the operating parameters are predicted iteratively at a predefined time interval.

14. A method for warning an operator about the future performance of a database management system (DBMS), the method comprising:
extracting historical data of one or more operating parameter for a predetermined time period;
removing outliers from the historical data;
smoothening the historical data;
fitting a mathematical model on the historical data;
calculating future values of one or more operating parameters based on the mathematical model, wherein the future values determine the future performance of the DBMS; and
warning the operator about the future performance of the DBMS.

15. A computer program product comprising a computer useable medium including a computer readable program, wherein the computer readable program when executed on a computer causes the computer to:
extract historical data of one or more operating parameters of a database management system (DBMS) for a predetermined time period;
build a trend of the historical data; and
predict the future performance of the DBMS by calculating future values of one or more operating parameters based on the trend.

16. The computer program product of claim 15, further comprising a computer readable program for removing outliers from the historical data.

17. The computer program product of claim 17, further comprising a computer readable program for smoothening the historical data.

18. The computer program product of claim 17, further comprising a computer readable program for warning a user of a critical system state on the basis of the future values of the operating parameters.

19. The computer program product of claim 17, further comprising a computer readable program for calculating a confidence value for each of the calculated future value of one or more operating parameters.

20. A system comprising:
at least one database; and
at least one computing system connected to the at least one database, the computing system comprising modules for:
extracting historical data of one or more operating parameters for a predetermined time period;
building a trend of the historical data; and
predicting the future performance of a Database management system (DBMS) by calculating the future values of one or more operating parameters based on the trend.
